(19) United States
(12) Patent Application Publication
(10) Pub. No.: US 2003/0088448 A1
(43) Pub. Date: May 8, 2003

(54) Multi-dimensional method and system for simulating strategic alliance of enterprises

(76) Inventor: Meng Ngee Philip Tan, Singapore (SG)

Correspondence Address: David C. Liu, LIU & LIU LLP, 811 West 7th Street, Suite 1100, Los Angeles, CA, 90017, US

(21) Appl. No.: 10/052,936

(22) Filed: Oct. 25, 2001

Related U.S. Application Data
(60) Provisional application No. 60/243,064, filed on Oct. 25, 2000.

(51) Int. Cl. G06F 17/60

(52) U.S. Cl. 705/7

(57) ABSTRACT

A three-dimensional system for simulating the life cycle of enterprise alliance is described. The system and method are actualized as a matrix correlating business strategy and alliance benefit payoff and further mapped onto an axis of strategic structural scenarios. By providing basic financial information of an enterprise, one can determine where the enterprise is in relation to its expected life cycle. More importantly, the same system and method also show graphically and analytically what an enterprise has to do to achieve the next level of performance in a possible strategic alliance.

### FIELD OF THE INVENTION

The present invention relates to a method and system for simulating strategic alliance of enterprises. In particular, the present invention pertains to a management diagnostic method and tool for identifying the stage, structure, and performance of a business alliance.

### BACKGROUND OF THE INVENTION

The past two decades have seen the emphasis of businesses gaining important competitive advantages. During this time, a significant amount of business research by academics, and applications by practitioners, have been centered on conceptualising and formulating various competitive strategies.

In the 1990s, these competitive strategies have resulted in direct confrontations amongst nations meeting their competition head-on (Porter, 1990). The increasing threats of trade wars between trading nations (for example, that between the US and Japan on the importation of Japanese cars), and the formations of the exclusive economic blocs of NAFTA (North American Free Trade Agreement), EEC (European Economic Community), APEC (Asia Pacific Economic Community) and other minor economic unions have, to a certain extent, transformed global free trade to a form of ‘global managed trade’. One response to these conditions has been the formation of various types of collaborative ventures and strategic alliances (Sasaki, 1993; Perimutter and Heenan, 1989).

The paces of technological change and market shifts have forced organizations to reconsider their strategies for creating sustainable competitive advantage. Also, strategic alliances focused on destabilizing market values are currently the most effective source of sustainable competitive advantage. Indeed, strategic alliances are often used as the next step for survival. That is, if the organisation cannot compete effectively, then it has to become partner dependent (Newman and Chaharbaghi, 1996). Alliances will continue its importance as a tool of competitive strategy; and a driving force behind this trend is the realisation by many firms that self-sufficiency is becoming increasingly difficult (Inkpen and Kon 1999).

Strategic alliances can also take an offensive form, particularly in fast-moving markets. Offensive alliances are driven both by speed and by the need to integrate disparate knowledge resources to create new market values where the resulting product has to combine different forms of knowledge, which could not possibly be owned by a single organization. In other words, it is a necessity (Newman and Chaharbaghi, 1996).

Strategic Alliances are today a fact of business life and are found on every corner of the corporate landscape (Spekman, Isabella, MacAvoy and Forbes III, 1998). As the major markets become more and more exclusive, head-to-head confrontation of the big players is likely to become more real in the impending global competition of the next century (Thurow, 1992). Globalisation mandates alliances, making them absolutely essential to strategy (Ohmae, 1989). In Japan in the 1960s and 1970s, a foreign business could gain access to the domestic market only through a joint venture, with a local partner. Increasingly, such joint ventures are needed in Europe and the US, as well (Drucker, 1992). As a result of this heightened competitive pressure and the world-wide scope of both technology and markets, many US firms have established new co-operative agreements with other organisations at home and abroad that involve unprecedented levels of sharing and commitment (Kanter, 1990).

In the 1990s, in a response to avert such dysfunctional head-to-head competition, there is an increasing awareness in academics, business consultants and corporate strategists on the merits of establishing strategic alliances. It was realised that co-operation and/or collaboration on a global scale, not only act as a defensive mechanism, but also enable flexibility and responsiveness to changes in the global business environment—a source of important competitive advantage in meeting global competition.

The current US auto industry's alliances with rival Japanese firms would have been unthinkable in the past (Yoshino & Rangan, 1995). Recent findings indicate that US firms with Japanese strategic alliance parties believe that their manufacturing cycle time for product introduction are more efficient than US firms without foreign affiliations (Bear, 1998). In this current global business environment, collaboration is just as common as competition. A natural selection process encourages organisations to share power or competition oriented strengths, for the simple reason that the fittest survive, and the weaker gets eliminated (Koning, 1994).

### OBJECT OF THE INVENTION

Considering the inadequacy of suitable frameworks in this area of business management studies, it is the objective of this research to formulate a comprehensive and generalized working model or framework that can identify those key qualities that affect the stability and endurability of strategic alliance. Such a framework will be useful for corporate strategists and alliance managers to refer to, in enhancing their understanding on some of the qualitative, but practical aspects about strategic alliance management, from a practitioner's point of view. In this regard, it is the aim that managers of strategic alliances and those involved in strategic management can learn to manage strategic alliances successfully.

In congruence with various scholars, practitioners and businesses, it is proposed that strategic alliance can be explained and described by focusing on the strategy, structure and performance of a strategic alliance at the corporate level (Yoshino & Rangan, 1995; Lorange & Roos, 1992; Lewis, 1990; Lynch, 1992; Segil, 1996; Park, 1992). By applying the Grounded Theory approach, this research will initially examine the dynamic nature of strategic alliance at the firm level, through the application of the ‘Strategy, Structure and Performance’ Paradigm (Snow et al., 1989). Ultimately, this research will describe the various stages on the life cycle of a strategic alliance, through a generalized conceptual framework, that is in line with the ‘Strategy, Structure and Performance’ Paradigm.

Following the approach of the paradigm, this research will also be looking into the South East Asian context of business alliances, for which this research is empirically based on. This will add new knowledge to scholars and practitioners and make known business choices and methods on the strategy, structure and performance of strategic business alliances in South East Asia.

### SUMMARY OF THE INVENTION

A three-dimensional system for simulating the life cycle of enterprise alliance is described. The system and method are actualized as a matrix correlating business strategy and alliance benefit payoff and further mapped onto an axis of strategic structural scenarios. By providing basic financial information of an enterprise, one can determine where the enterprise is in relation to its expected life cycle. More importantly, the same system and method also show graphically and analytically what an enterprise has to do to achieve the next level of performance in a possible strategic alliance.

### BRIEF DESCRIPTION OF THE DRAWINGS

FIG. 1 is a 2-dimensional process mapping on strategic alliance performance-strategy model of the present invention.

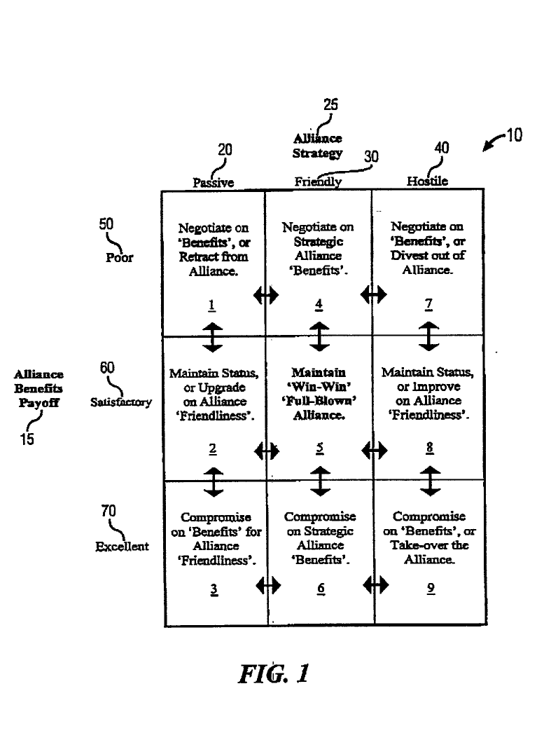

FIG. 2 is a representative checklist of activities that an alliance in the rationalization stage would undertake.

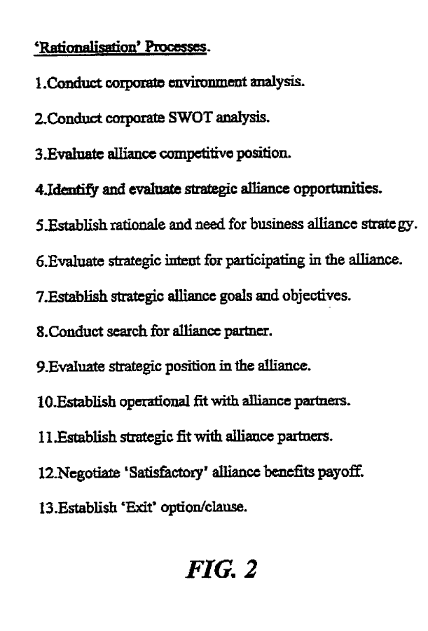

FIG. 3 is a representative checklist of activities that an alliance in the formation stage would undertake.

FIG. 4 is a representative checklist of activities that an alliance in the failure stage would undertake.

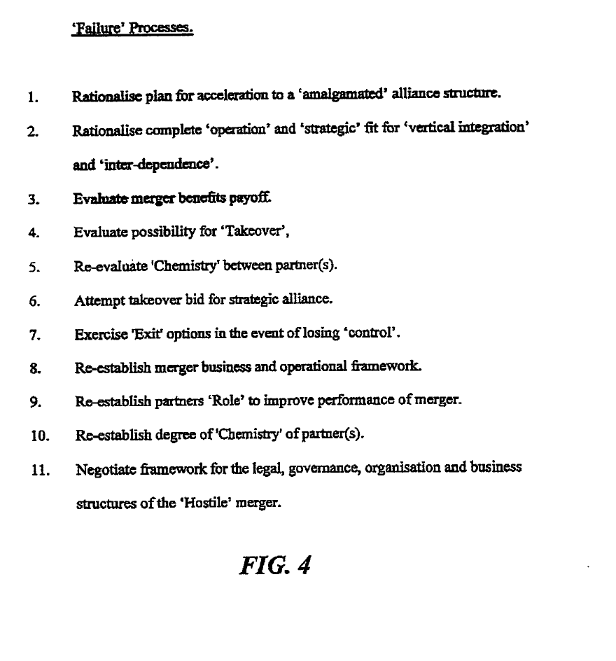

FIG. 5 correlates the various stages of an alliance to the strategy, structure and performance matrix of the present invention.

FIG. 6 is a three-dimensional graphical representation of the strategy, structure and performance matrix illustrating the framework of the present invention.

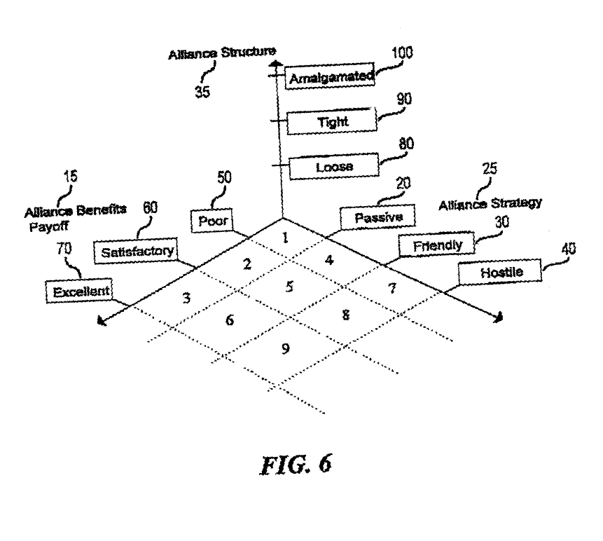

FIG. 7 illustrates a game play or scenario planning for a variety of alliance combination in accordance to one embodiment of the present invention.

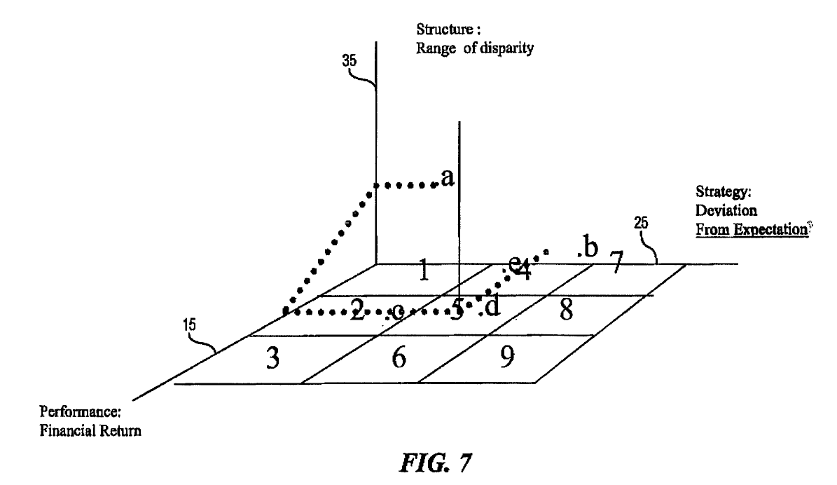

FIG. 8 shows an online implementation of an embodiment of the present invention in diagnosing the stages and options of an alliance.

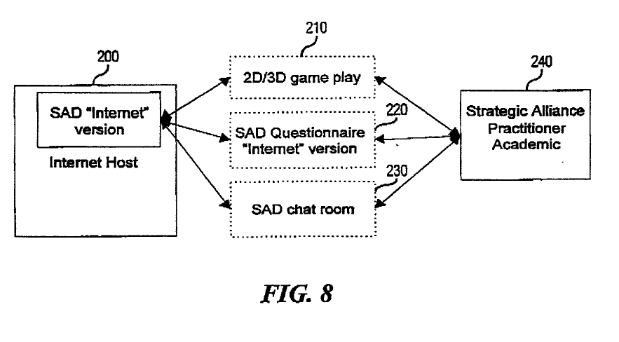

### DETAILED DESCRIPTION OF THE INVENTION

Passive, Friendly and Hostile

Lynch's (1992) book ‘How to plan, negotiate, and manage strategic partnerships for increased corporate profits’ flows along the principal concepts on alliance as a strategy basically revolving around issues that of, alliance rationalising, partner search, alliance structure, managing alliances and avoiding alliance failure. (Lewis, 1990; Lorange and Roos, 1993; Lynch, 1993; Yoshino and Rangan, 995). Central to this strategy is the need to remain a “friend”.

At the 1990 International Conference of the Planning Forum held in Washington, D.C., the conference kickoff speaker, Harvard professor Rosabeth Moss Kanter described four major characteristics that characterised the corporation that will succeed in the 1990s. They are what she referred to as the four Fs; Focused, Fast, Flexible and ‘Friendly’. The ‘National Council of Individual investors’ released a study ranking the 1,000 largest U.S. corporations accordingly to its appraisal of their financial performance and corporate-governance practices. The ranking was conducted in an in-house scoring system, which rated corporations as ‘most or least friendly’ to shareholders (AWSJ, 19^{th} April 196, p. 11).

Lorange and Roos (1992) have proposed that several partners could also decide to back a certain business idea, as relatively ‘Passive’ investors from the start. Various comics and practitioners have also argued that the careful ‘Rationalization’ of alliance, objectives, intent, strategy and a rigorous partner search will achieve a ‘win-win’ position, or a ‘full-blown’ joint venture for the partners. Their argument is based on the premise that in light of the heightened global competition, it is increasingly impossible to go about business venture by themselves alone, that business have come to realize that only by working together can excellent rewards be reaped (Yoshino and Rangan, 1995; Lynch, 1992; Lewis; 1990; Lorange and Roos; 1992).

Lorange and Roos also argued that the independent adult and passive form of strategic alliance could potentially continue for a long time, provided that it remains competitive and yields satisfactory return to the partners. If the investment that the passive partners require does not accrue, the strategic alliance would normally be terminated (i.e. alliance failure). While another option can be one of the partners buying-out or ‘taking-over’ the others, and, Lorange and Roos described this as ‘quite a normal type of event’ (Lorange and Roos, 1992). Various researchers have suggested that strategy alliance is sometimes a prelude to a ‘Hostile’ take-over attempt (Lynch, 1993; Lewis, 1990; Yoshino and Rangan, 1995; Lorange and Roos; 1992).

Following the ‘Iterative Nature’ of ‘Game-Theory’ under ‘Operation Research’, a ‘Map on the process of Game-Play Dynamism of Strategic Alliance’ can be observed and be described accordingly, in either ‘Progressive or Regressive Stages’.

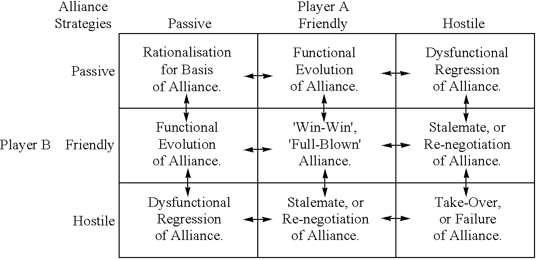

Process Mapping on Strategic Alliance Game-Play Dynamism. By ‘Friendly’, it is defined in this research that the party courting the alliance has in true fact, chosen a ‘cooperative-collaborative’ attitude towards putting an effort to achieve the desired win-win position, without any ulterior motives of either taking over the company, or learning any ‘tacit informatin or knowledge’ from its potential partner(s) (Horton, 1991).
# Lastly, contrary to the ‘Friendly’ definition, the opposite ‘Hostile’ can be defined as those firms that seek the alliance with some other ulterior motivations (Lynch, 1993; Yoshino and Rangan, 1995), While the ‘Passive’ strategy can only be defined as the strategy employed by a ‘passive investor’ desiring only satisfactory returns (Lorange and Roos, 1992).

Defining Strategic Alliance Structure Component Variables

Loose, Tight and Amalgamated

In the evolutionary pattern of strategic alliance developments stages, Lorange and Roos (1992), assumed that after taking in the life-cycle consideration, proposed that strategic alliances can only evolve from more simple (i.e. loose) to more complex forms (in five different stages of particular order) over time, and not the other way around. They also warned that a ‘Full Blown Joint Venture’ is not universally more desirable than a ‘Loose’, ad hoc pool type of venture.

From ‘Loose’ here, we can progressively categorise the ‘complex forms’ of strategic alliances into three classes; ‘Loose, Tight and Amalgamated’. Where, ‘Loose’ is associated with the simple form of alliance that is low or none, on degrees of ‘inter-dependency’ and ‘vertical integration’. This form of alliance is defined to be those that can be entered into and exit from ‘Easily’. Usually, this is done in the form of a non-equity based, formal or informal arrangement or structure.

‘Tight’ is associated with a moderately complex form of alliance that is moderate in ‘inter-dependency’ and ‘vertical integration’. This form of alliance is defined to be those that can be entered into and exit from ‘With Difficulty’. Usually, this is done in the form of an equity based jointed ownership, or joint venture (fully blown) arrangement or structure.

Research Variables on Alliance Structure

| Lorange & | Degree of | Formal or | Joint | Merger |
|---|---|---|---|---|
| Roos | Vertical | Informal | Ownership | and |
| (1992) | Integration | Cooperative | or | Acquisition |
| | | Venture | Joint Venture | |
| | Degree | None | to | Large |
| Contractor | Degree of | Formal or | Joint | Merger |
| & Lorange | Inter- | Informal | Ownership | and |
| (1988) | dependency | Cooperative | or | Acquisition |
| | | Venture | Joint Venture | |
| | Degree | Low | to | High |
| Defining | Degree of | Easily | With | Almost |
| Alliance | Separability | | Difficulty | Impossible |
| Structure | of Key | | | |
| | Alliance | | | |
| | Assets | | | |
| | Correlating | | | |
| | to | with | with | with |
| Research | Degrees of | Tight | Tight | Amal- |
| Definition | Strategic | | | gamated |
| Adopted | Alliance | | | |
| on | Structure | | | |
| Structure | | | | |

Correlation on the degrees of ‘inter-dependency’ and ‘vertical integration’, to the degrees of ‘separability’ and their corresponding form of ‘loose, tight and amalgamated’ alliance arrangements or structures
‘Amalgamated’ is associated with an ‘irreversible’ form of alliance that is high in ‘inter-dependency’ and ‘vertical integration’. This form of alliance is defined to be those that at the extreme point of ‘inflexibility’, where once entered into, it is ‘Nearly Impossible’ to exit from. Usually, this is done in the form of an arrangement, or structure that is consistent with mergers and acquisitions.
A definition on ‘Degrees of Separability of Key Alliance Assets’ on strategic alliance is adopted here, after extending from Lorange and Roos (1992) definitions on strategic alliances on ‘Degrees of Inter-dependency and Vertical Intergation’.
This also goes along their second key consideration in strategic alliance on what ways a particular party is able to dispatch, as well as retrieve, specific, identifiable strategic resources to and from the strategic alliance, based on whether this resource allocation, represents a reversible or irreversible move.
This deals with whether future strategic flexibility is of paramount importance with regards to a partner's resources being ‘Separable’ from the strategic alliance itself).

From the various arguments, this research study found the degrees of ‘Easily, With Difficulty and Almost Impossible’ in separating key alliance assets, to be directly correlated to the ‘Loose’, ‘Tight’ and ‘Amalgamated’ structures, respectively.

Defining Strategic Alliance Performance Component Variables

Poor, Satisfactory and Excellent

Lynch (1992) put forward a strong argument on, ‘How to plan, negotiate, and manage strategic partnerships for increased corporate profits’. His first objective was to improve the chances of obtaining ‘Excellent’ results from an alliance. Lynch (1992) proposed that rewards and risks are correlated to alliance strategies. He also argued that the most difficult drawback in the alliance development is the search for the right partner. This is critical because the wrong match would yield ‘Poor’ or negative results. It is also between the range from ‘Poor’ to ‘Excellent’ rewards, that there exist another classification of what Lorange and Roos (1992) proposed as ‘Satisfactory’ returns.

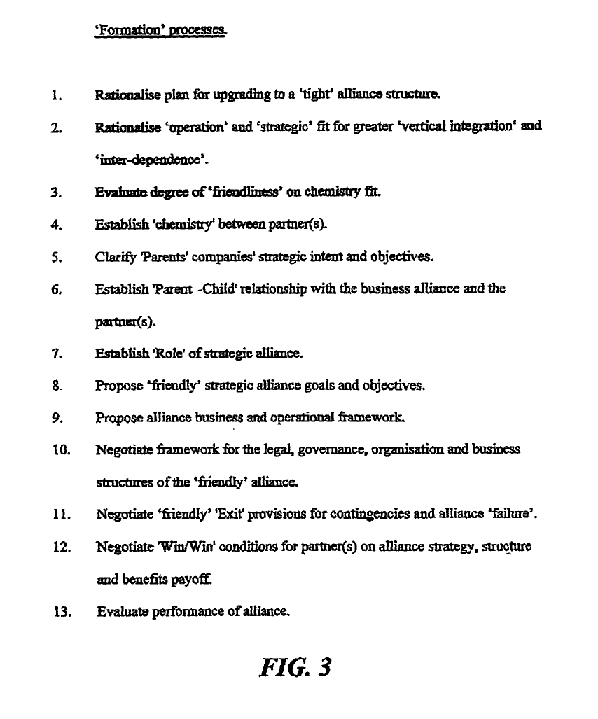

In extending Lynch (1992)'s analysis, and on studying the relationship between ‘Alliance Strategy, Alliance Structure and Alliance Performance’ (FIG. 3.3), four observations can be made.

1. Different degrees of alliance strategies, in conjunction with different degrees of alliance structures, proposed to yield different degrees of alliance benefits (i.e. payoffs).

2. Alliance strategy (‘Passive, Friendly and Hostile) is correlated to alliance benefit, where, Benefits from Joint Ventures (i.e. ‘friendly’).

Is greater> Benefits from Mergers (i.e. ‘hostile’).

Is greater> Benefits from Strategic Alliance (i.e. ‘friendly’),

Is greater> Benefits from OEM and Licensing agreements (i.e. ‘loose’).

3. Alliance strategy is directly correlated to alliance structure,

A ‘Merger’ strategy can be correlated with and ‘Amalgamated’ structure.

A ‘Strategic Alliance, and Joint-Venture’ strategy can be correlated with a ‘Tight’ structure, and

‘OEM and Licensing agreements’ can be correlated with ‘Loose’ Structures.

4. By the ‘Mathematical Rule on Transitive Addition’, it can be seen that alliance structure is also correlated with alliance benefit.

A 3-Dimension Conceptual Framework on Strategic Alliance Dynamism

Cowherd and Luchs (1988) conducted a research study, OASIS (Organization and Strategy Information Service), on ways of organizing to implement business strategies. This 1984 study was a joint venture among the Hay Management Consultants, the Strategic Planning Institute and the University of Michigan. The initial research results indicated that there are strong relationships between business strategy, organization (i.e. organization structure) and performance.

This outcome is empirical evidence to suggest that the ‘Environment, Strategy, Structure and Performance’ framework is sound and relevant. Applying the concepts behind the ‘Environment, Strategy, Structure and Performance’ theoretical framework, a three dimensional (X-Y-Z) model is proposed here, to portray the complete set of relationships among the elements, and their components.

2-Dimensional Process Mapping on Strategic Alliance's ‘Strategy-Performance’ Game play

Deriving from the various theorems, observations and research of various academics and practitioners, a ‘2-Dimensional Process Mapping on Strategic Alliance Strategy-Performance Game play’ can be charted in the form of a 3×3 matrix.

Assumptions

The following assumptions are adopted in arriving at the 2-Dimensional Process Mapping on Strategic Alliance ‘Performance-Strategy’ Dynamism.

1. The mapping adheres to the rules on ‘Game Theory’, on the iterative nature of arriving by the ‘Saddle’ point of the ‘Optimum’ or the ‘win-win’ solution.

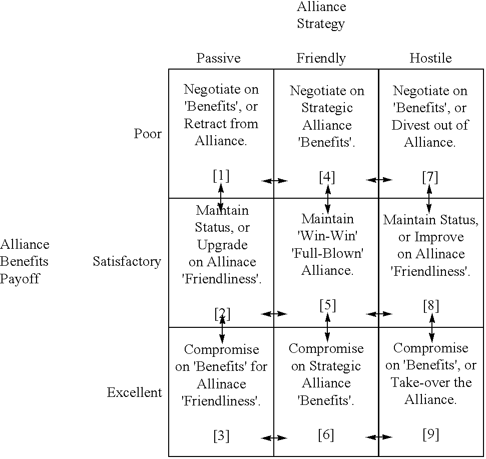

2-Dimensional Process Mapping on Strategic Alliance ‘Performance-Strategy’ Dynamism.
2. A wise businessman will not seek advantage to the point where he generates dangerous hostility (Carr, 1968).
3. The mapping is consistent with Lorange and Roos (1992) on their theory on strategic alliance evolutionary stages.
4. An ‘OEM or Licensing’ arrangement is defined as a ‘Passive Strategy’.
5. A ‘Strategic Alliance, Joint Ownership or Joint Venture’ is defined as a ‘Friendly Strategy’.
6. A ‘Take-Over’ is defined as a ‘Hostile’ strategy.
7. The ‘degrees of benefits payoff’ for each of the alliance strategy employed (Passive, Friendly, and Hostile), is ‘mutually exclusive’.
8. Benefits (Poor, Satisfactory and Excellent) on payoffs is correlated with the respective alliance strategies (Passive, Friendly and Hostile) adopted, where
Benefits from Joint Ventures (i.e. ‘Friendly’).
Is greater > Benefits from Mergers (i.e. ‘Hostile’).
Is greater > Benefits from Strategic Alliance (i.e. ‘Friendly’).
Is greater > Benefits from OEM and Licencing agreements (i.e. ‘Loose’).

Arguably, from the “2-D alliance game-play” analysis, there is no reason for partners to upgrade from a ‘passive’ [2] to ‘friendly’ [5] strategy unless the ‘payoffs’ are greater for the ‘friendly’ strategy. This is indeed the case, when the element of alliance ‘structure’ is added as another variable to arrive by the 3-dimensional conceptual framework on strategic alliance dynamism.

It can also be argued that,

1. The ‘Passive’ approach can be described to be a ‘Stage’ where, the prospective alliance partners are on a long-term ‘Rationalization’ plan about the alliance relationship, and this stage can be defined to be that of ‘Alliance Rationalization’. Here it is defined that the level of alliance is ‘Low’ on ‘Inter-Dependence, Vertical Integration and Separability’ (i.e. Alliance Structure), and low on ‘Alliance Benefits Payoff’ (i.e. Alliance Performance), such that an ‘Exit’ from the alliance can be done ‘Easily’.

2. Similarly, the ‘Friendly’ approach can be defined to be one of ‘Alliance Formation’. Here it is defined that the level of alliance is ‘Tight-to-Amalgamated’ on ‘Alliance Structure’, and ‘Satisfactory-to-Excellent’ on ‘Alliance Benefits Payoff’, such that an ‘Exit’ from the alliance will meet ‘With Difficulty’.

3. And, the ‘Hostile’ approach can be defined to be one of ‘Alliance Failure’. Here it is defined that the level of alliance is ‘Amalgamated’ on ‘Alliance Structure’, and ‘Above Average’ on ‘Alliance Benefits Payoff’, such that an ‘Exit’ from the alliance is ‘Almost Impossible’.

3-Dimensional Conceptual Framework on Strategic Alliance Dynamism

It can be observed that, upon adding the element of alliance structure to the performance-alliance matrix, the evolutionary path, or ‘Stages’ of strategic alliances is a ‘progressive’ form of structures evolving into higher degrees of ‘Inter-dependency, Vertical Integration and Inseparability’, and is correlated with alliance benefits payoff. In this light, the final 3-Dimensional Mapping Model on Strategic Alliance can be charted.

The various ‘Processes’ and ‘Actions’ that occurred in ‘Stages’, within the matrix, can be described to be Iterative (Snow, 1988), evolutionary (Lorange and Roos, 1992), and are consistent within the arguments of the strategic alliance ‘Road-Map’ (Yoshino and Rangan, 1995) and ‘Pyramid’ (Lynch, 1992), which can accounted and described accordingly.

[image]

The three ‘Stages’ are now identified in the 3-D framework, and in accordance with the iterative and asymmetrical nature of the ‘Strategy, Structure and Performance’ paradigm. It can be described that,

1. Rationalization stage correlate to a ‘Passive, Loose and Poor-Satisfactory’ matrix.

2. Formation stage correlate to a ‘Friendly, Tight and Satisfactory/Excellent’ matrix.

3. Failure stage correlate to a ‘Hostile, Amalgamated and less than Excellent’ matrix.

However, all three stages are mutually exclusive to each other. Although before the players were to ‘Fixed’ their structure, it is still conceptually possible to move down, or up one stage. However, once the business ‘structure’ has been fixed, the alliance will experience greater ‘inter-dependency, vertical-integration’ and ‘Inflexibility’.

| | Stages | Strategy | Structure | Performance |
|---|---|---|---|---|
| [1]. | Rationalization | Passive | Loose | Poor-Satisfactory |
| [2]. | Formation | Friendly | Tight | Satisfactory-Excellent |
| [3]. | Failure | Hostile | Amalgamated | Less than Excellent |

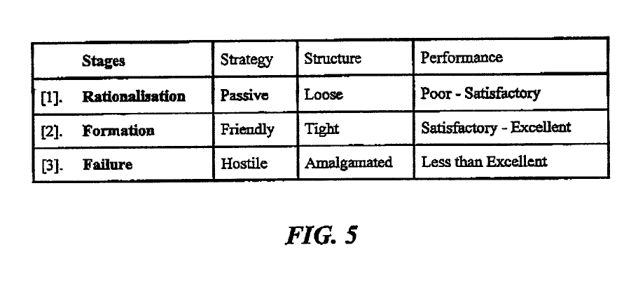

FIG. 5 Correlation between Stages of an alliance to the “Alliance Strategy, Structure and Performance” Matrix.

Rationalisation Stage

During the Rationalization stage, at the outset, when considering a alliance strategy, most of the preparatory work is done at square one [1], in the 2-Dimensional ‘performance-Strategy’ process mapping, employing first a ‘passive’ strategy with a ‘Loose’ structure, negotiating off from a theoretical ‘Poor’ likely payoff on alliance benefits.

At the beginning [1], the alliance game play on negotiating at [1] for player ‘A’ and compromising at [3] for player ‘B’, should dynamically change the degree of alliance benefits payoff, before arriving by the optimal solution at [2] for both players, while employing a ‘Passive’ strategy and a ‘Loose’ structure.

However, at [1], should the ‘Rationalization’ test for the proposed strategic alliance failed, player ‘A’ should ‘Retract’ from the alliance. On the other hand, should the proposed alliance pass the test, both players should negotiate and compromise on moving to the position [2] of ‘Satisfactory’ alliance benefits, before considering ‘Upgrading’ the alliance to one of ‘friendly’ strategy and ‘Tight’ structure. A prescription on the ‘Rationalization’ process of ‘How-to’ start off a strategic alliance is suggested here.

Formation Stage

When partners in a ‘Passive, Loose, Poor’ position decided to ‘Upgrade’ the alliance to one of ‘Friendly, Tight, Satisfactory/Excellent’ position, the alliance game play on negotiating at [4] for player ‘A’ and compromising at [6] for player ‘B’, should dynamically change the degree of alliance benefits payoff, before arriving by the optimal solution at [5] for both players. At the ‘Formation’ stage [5], in order to negotiate and maintain a ‘Win-win’ position for the players, an ‘Upgrade’ version on alliance ‘Rationalization’ and ‘Negotiations’ would be required.

When upgrading from [2] to [5], the ‘Formation’ process would swing to-and fro between [4] to [5] to [6]. This process would require what studies have argued, to require a good ‘chemistry’ fit (Lynch, 1992), a good ‘choice of partner’ (Lynch, 1992; Yoshino and Rangan, 1995) and shareholders' blessings (Lorange and Roos, 1992). A prescription list on the ‘Formation’ process is described here.

At [5], there are two options open for both players to strategies should the ‘Upgrade Rationalization and Negotiation Process’ for the proposed strategic alliance fail.

1. The first option is for both players to ‘Regress’ by “falling down” into the lower ‘Passive, Tight and Poor’ alliance ‘Rationalization’ [2] stage. Here, the players will have to accept that the ‘friendly’ strategy has failed, and both players have to cordially accept a more arms-length approach to cooperation.

2. The second option is for both players to accelerate the alliance ‘Failure’ process, by upgrading to the ‘Hostile’ [8] stage. An inability to resolve mutual interests here to return to the ‘Formation’ [5] stage will eventually result in the ‘Take-Over’ of the alliance by one player and the ‘Exit’ of the other. However, if both parties are satisfied of the alliance benefits payoff, then it is not impossible to maintain both parties' position here at [8]. However, this deemed not to be an effective strategy because the hostility between partners will affect alliance benefits payoff, such that payoff at the ‘Hostile’ stage [8] is ‘Lower’ than that at [5].

On the other hand, should the upgraded alliance be successful, both players will have to negotiate and compromise on the eventual ‘Formation’ and ‘Maintenance’ of the ‘Win-Win’, or ‘Full Blown’ alliance position [5]. Here, although alliance benefits payoff is ‘Satisfactory’, the greater degree of ‘Inter-dependency and Vertical Integration’ would yield a ‘Higher’ payoff in [5], than at [2].

Although, the position [5] is observed to yield the greatest alliance performance in payoffs, this position also represents to be the most ‘DANGEROUS’ part of strategic alliance. Once the strategic alliance is ‘Formed’ at the ‘Friendly, Tight and Satisfactory’ position [5], it will be ‘Difficult’ for partners to disengage themselves from the alliance if partners' ‘chemistry’ turned ‘sour’ and ‘hostile’. At which point, it may be too late to down grade to a ‘Rationalization’ stage [2], but there exist a greater propensity to motivate the partners to escalate to the alliance ‘Failure’ [8] stage.

Failure Stage

At the ‘Failure’ [8] stage, should the partners not work to down grade tensions to the ‘friendly’ stage, or if alliance performance deteriorates below satisfactory levels for both partners, then there is every possibility for the eventual ‘Take-Over’ by one player, and ‘Exit’ of the other player. Even if the players are able to maintain the position [8], it will mean that one player have taken ‘Control’, while the other player becomes a ‘passive’ investor. A prescription list on the ‘Failure Process’ is described here.

Hypotheses and Observations

Gay and Diehl (1992) stated that a hypothesis should be based on sound rationale, and it should follow from previous research and lead to future research; its confirmation or disconfirmation should contribute to management theory or practice. They also stated that a good hypothesis provides a reasonable explanation and should have the following characteristics, which the questionnaire has attempted to be based on.

1. States as clearly and concisely as possible the expected relationship (or difference) between two variables,

2. Defines those variables in operational, measurable terms.

3. Should normally be testable within some reasonable period

Hypotheses are raised to establish certain facts, clarify certain ‘myths and truths’, and to establish the existence of any relationships. The hypotheses and observations of this study are formulated largely by the deductive approach, and are logical questions found in the literature review of other researchers and practitioners.

The primary motivation offered in this research is that S.E.A. businesses must consider strategic business alliance to be a viable option in pursuing regional opportunities. This research paper has developed and presented a strategic alliance dynamism framework which describes the dynamic Interplay among alliance strategy, alliance structure and alliance performance. Major hypotheses were developed to test the support for the above conceptual framework using the empirical data collected from the SEA region.

The first hypothesis concerns the need for a strategic alliance framework in the SEA context, and can be stated as:

H1: SEA businesses need a strategic alliance dynamism framework to understand the processes and issues involved in managing the alliance for greater stability and endurability.

The second hypothesis leads from the first hypothesis and deals with the introduction of the alliance ‘structure’ as an equally important component of SAD conceptual framework.

H2: within the 3-dimensional Strategic Alliance Dynamism Framework, Alliance Structure is an equally important component to strategy and performance.

The third hypothesis then proposes that because of its dynamic nature, the Strategic Alliance Dynamism framework has universal appeal. This hypothesis will be tested with reference to the data collected from the Southeast Asia respondents.

H3: Responses to the Strategic Alliance Dynamism framework are Independent of the country of origin in the Southeast Asian context.

To support the above hypotheses, other issues and questions have been researched and raised from a review of the appropriate literature as well as personal interviews with experts within the selected South East Asia countries.

Some of these observations raised and the context in which they were raised are given below.

Observations under definition of strategic alliance/entry strategy,

1. Businesses prefer to employ strategic alliances as the effective strategy to their REGIONAL new business ventures.

2. Businesses prefer to employ strategic alliances as the effective strategy to their new business ventures.

3. In a business alliance, partner(s) should share the benefits and control of the Joint Venture.

4. Mergers, takeovers and acquisitions in which one firm assumes effective control, are not alliances.

5. Overseas subsidiaries of S.E.A. businesses, even if they are joint ventures, are not alliances.

6. Licensing and franchising agreements, because they do not call for the continuous transfer of technology, products or skills between partners, are not strategic alliances.

7. Cross-licensing arrangements that involve continuing exchange of technology, but not the sharing of control over technology related tasks, are not strategic alliances.

2-Dimensional Strategic Alliance Game play mapping

Rationalisation Stage Mapping

Yoshino and Rangan (1995) observed that firms often entered into alliances on an ad hoc basis driven largely by immediate or tactical concerns and such moves often have disastrous results. Newman and Chaharbaghi (1996) also stated that some strategic alliances happen because they have to happen, with each party having something to offer which make a marked difference. Considering the developing economies of most S.E.A countries, many businesses of this region are young and are therefore not well versed in contemporary business theories and practices. Therefore, Yoshino and Rangan's (1995) observations should be more prevalent in the S.E.A. setting.

Observations under strategy development process,

1. S.E.A. businesses often enter into alliances on an ad-hoc basis that is driven largely by immediate or tactical concerns.

2. A process of the ‘Partner Search’ is the first step to take towards forming a Strategic alliance.

3. S.E.A. businesses often enter into alliances on the advice of its professional managers, merchant bankers, public accounts, corporate lawyers or government agencies.

4. S.E.A. businesses do not normally conduct formal evaluations (e.g. SWOT analysis) on reassessing the business that they are in.

5. S.E.A. businesses do not normally conduct formal evaluations on their mode of competition.

6. S.E.A. businesses do not normally conduct strategic planning on achieving important long-term objectives and goals.

7. S.E.A. businesses do not scan its environment to search out opportunities to enhance their competitive position.

8. S.E.A. businesses normally search for opportunities of gaining advance know-how and capabilities globally in their efforts to enhance their competitive position.

9. S.E.A. businesses will venture out on a new business opportunity only when the five key components of ‘Technological Know-How’, ‘Social and Business Network’, ‘Product/Service Idea’, ‘Resources’ and ‘Market/Customers’ are present.

10. The winning edge for S.E.A. businesses in fast-changing industries, is to be able to locate key developments before others.

11. S.E.A. businesses operate more entrepreneurially than American or European companies in Asia.

The first critical step to a successful strategic alliance is picking the right partner for the right reasons. (Bruton and Samice, 1998) Lewis (1990) argued that starting with the right partner is a key to future success, where a poor choice could mean lost time and foreclosed opportunities. Lynch (1992) described the most difficult drawback in the alliance development is the search for the right partner. This is critical because the wrong match would yield poor or negative results (Lynch, 1992). Dr. Ng Kah Hwa, Head of the Division of Banking and Finance (Nanyang Technological University of Singapore), had also suggested that the Singapore industry's owner confidence in the merchant banking industry was fragile.

In Bruton and Samiee's 1998 article “Anatomy of a Failed High Technology Strategic Alliance”, both writers attributed western firms' failure with emerging economies partners as partly due to overlooking the importance of networking. Hara and Kanai (1994) suggest that in order to entrepreneurially network across oceans to promote international alliances for small businesses, the key to success is a person or company that is a ‘net worker of networks’, who is able to create a global network of networks. Also, those social events, such as international symposia, exchange programs or conventions are important mechanisms for identifying potential partners with different resources.

In current times, the organization of international business has evolved from an uncontrolled chaos to diversified conglomerates, to focused business units, and finally to collections of units with core competencies, creating a network of strategically structured business cells (Hinterhuber and Levin, 1994). These are also what Yoshino and Rangan (1995) have predicted to be the frontier on managing the ‘Global Network Corporation’.

Following this argument, this would suggest that businesses in S.E.A. would prefer to cooperate with familiar business associates within their social and business networks, and would tend to rely less on merchant banks. Also, ideally, International alliances should be supported by a partnership philosophy. (Shaughnessy, 1995)

Observations under partner selection process,

1. Businesses do not normally employ a formal systematic ‘partner search’ process to identify their ideal partner.

2. Businesses will only choose to work with familiar business associates from existing related or extended networking social and business relationships.

3. Having the right partner is the key to future alliance success for S.E.A. businesses.

4. A poor choice of partner(s) can lead to lost time and opportunities for S.E.A. businesses.

Yoshino and Rangan (1995) suggest that the appropriate structure should facilitate the realization of a firm's strategic objectives and be operationally feasible. Brouthers, Brouthers and Wilkinson through their 1995 article “Strategic Alliance: Choose Your Partners” also highlighted “the four Cs'”; complementary skills, cooperative cultures, compatible goals and acceptable risk levels as key issues to be addressed in forming a suitable structure for the alliance to work. Lynch's argument is that ‘Form’ (i.e. Structure) follows ‘Function’. This would suggest that the various strategic and operational functions have priority in considering the viability of the alliance.

Observations under strategic & operational fit-implementation issues,

1. S.E.A. businesses normally consider the ‘strategic and operational fit’ of the business alliance to be more important than the ‘chemistry fit’ among the partner(s).

2. S.E.A. businesses normally consider that the employment of alliance-based entrepreneurial strategies can counteract the competitive actions in all of its market segments.

3. S.E.A. businesses normally consider alliance-based strategies to be basically “defensive” competitive strategies.

4. S.E.A. businesses normally consider alliance-based strategies to be basically “offensive” strategies in meeting global competition head-on.

5. Senior managers of S.E.A. businesses are able to develop an intuitive sense on the role of the alliance in their business.

6. Failure to recognise and define the role of the alliance is responsible for much of the dysfunctional interfirm relationships for S.E.A. businesses.

7. S.E.A. businesses do not normally consider alliances to be ‘quick fixes’, but as strategies that contribute to its long term strategic performance.

8. S.E.A. businesses usually create fallback positions so as to be not totally dependent, on the alliance.

9. S.E.A. businesses usually maintain a set of strategic options as defense to the ally's turning adversary (i.e. Alliance Exit Option).

10. S.E.A. businesses usually maintain a set of strategic options as a mechanism for coping with future developments (i.e. additional partner(s), capital investments, business development, sharing of benefits, etc).

Rationalisation Stage, Mapping on Alliance Benefit Payoffs

Three observations are raised here to establish the degrees of confidence of the relationship between, the ‘Passive’ alliance strategy and its corresponding levels (‘Poor, Satisfactory, and “Excellent’) of expected, or real ‘benefit payoffs’.

Observations,

1. When S.E.A. businesses execute a “Passive”, but objective and systematic approach towards the ‘Partner Search’ process, net strategic benefits are usually expected to be poor, when ideal partner(s) cannot be found.

2. When S.E.A. businesses execute a “Passive”, but objective and systematic approach towards the ‘Partner Search’ process, net strategic benefits are usually expected to be moderate, when ideal partner(s) have been identified.

3. When S.E.A. businesses execute a “Passive”, but objective and systematic approach towards the ‘Partner Search’ process, net strategic benefits are usually expected to be excellent, when ideal partner(s) have be found.

Formation Stage Mapping

Lynch (1992) had explained that in addition to placing importance on both strategic and operational fit, another important additional fit in strategic alliance that needs to be included is that of ‘Chemistry’. ‘Chemistry’ is a measure of the ‘quality of the relationships’ among the people involved in the operating alliance and the maintenance of the win/win alliance formula is critical in alliance success.

Yoshino and Rangan (1995) shared a different view in that to them, any agreed-upon alliance structure was to be a product of bargaining power through negotiations. This iterative negotiation process should only be entered into after having weighed the relative importance and recognized the complex interrelationships among the factors of ‘strategic, operational and chemistry’. The focus should be on understanding the culture of the company and its people, and not only on its assets alone. (Sonnenberg, 1992) Also, foreign companies wanting to do business in an Asian developing country need to develop personal relationships, especially to gain access to highly-placed government people who can clear away problems and red tape (Konopacki, 1992). Difficulty in gathering and interpreting intelligence in Asia Pacific could be attributed to either the lack of familiarity with the culture or with contacts (Lasserre, 1993).

Therefore, in S.E.A., superior Chemistry’ or ‘relationships’ is proposed to be more important than binding contracts in ensuring the success of the proposed alliance. However, it must again be reiterated that cultural differences can be managed and accommodated for, but differences in core values cannot (Spekman, Isabella, MacAvoy and Forbes III, 1996).

Observations relating to relationship formation issues,

1. S.E.A. businesses normally consider superior ‘Chemistry’ (i.e. relationships) to be more important than binding contracts, in ensuring the success of the proposed alliance.

2. S.E.A. businesses normally consider that their own integrity and reputation is more important than the success or failure of the business alliance.

3. S.E.A. businesses normally consider themselves to be trust worthier than American or European businesses.

Cross-cultural negotiation has taken on an increasingly important process to the globalising firms. Burton and Samiee, (1998) mentioned that it is important that during negotiations a strong relationship between the two potential partners be developed and cultures appreciated. Like personal relationships, they believe strategic alliance requires a degree of trust and flexibility. Unfortunately, cultural differences are often used as an excuse for problems rather than being their real source (Shaudhnessy, 1995).

Here, culture forces people to view and value differently the many social interactions inherent in fashioning an agreement (Gulbro and Herbig, 1994). In S.E.A., business deals have known to be concluded on the golf course or during dinner. The interest thus lies in finding out the preferred approach to alliance negotiations by S.E.A. businesses. A study on “conflict resolution strategies of Canadian and Chinese (People's Republic of China) executives” was conducted by Tse, Francis and Walls(1994).

The Research findings indicated that neither group of executives altered their strategy for negotiating across cultures and that ‘Person-related’ (i.e. relationship based) conflicts were found to generate more negative responses than ‘Task-related’ conflicts (Tse et al., 1994). This suggests that Asian businessmen are of the opinion that an informal approach would be less stressful and more favorable on the outcome of alliance negotiations. Hence, western executives must confront attitudes and behavior among their business partners in the Asia Pacific region that may differ fundamentally from their expectations. Shaughnessy, (1995), asserted that cross culture alliances inherently involve differences of opinion. Survey results indicated that with the exception of Singapore and Hong Kong, Asia Pacific is perceived as complex and unfamiliar to a large proportion of western managers (Lasserre and Probert 1994).

Observations under negotiation process,

1. Businesses prefer to employ an informal approach to alliance negotiations with their prospective partner(s).

2. Businessmen usually practice the ‘give-and-take’ principle for alliance negotiations.

3. Businesses prefer to negotiate in the informal settings of a country club, restaurant, golf course, etc.

4. Businessmen usually do not bring along their professional managers, merchant bankers, accountants, corporate lawyers or close business associates during the initial phases of business alliance negotiations.

5. Businesses usually view the final phase of drawing the alliance agreement to be compliance to conventional requirements and are not as crucial as the mutual understanding achieved between partner(s).

6. Businessmen usually observed good manners and behavior during negotiations.

7. Businessmen are usually not emotionally affected adversely even if the alliance negotiations have gone badly, as they consider the preservation of the business relationship to be more important to the opening of future opportunities.

Lynch's pointed out that from an informal survey of nearly 1,000 top ranking executives, overwhelming concern for the perceived loss of control in strategic alliances appeared to be an important issue. Also indicated was ‘a strong aversion to the 50:50 joint ownership venture’. This perspective was argued to be the different business culture distinguishing American from European and Asia businesses. Drucker argued on the contrary that the alliance, whatever its legal form, has to be managed by one of the partners and cannot be managed by a committee. This prospective is contrary to most researchers who have argued that alliance required the sharing of control (Lewis, 1990; Yoshino and Rangan, 1995).

Observations under control mechanism issues,

1. S.E.A. businesses usually prefer control in the proposed alliance than otherwise having to share it.

2. S.E.A. businesses generally believe that total control increases the chances of success for the new business venture.

3. S.E.A. businesses generally do not prefer the 50:50 equity joint venture, or joint ownership alliance structure.

4. S.E.A. businesses generally prefer management control tools over equity control mechanism.

Lynch (1992) stated that ‘a successful alliance is not a happenstance occurrence related to the luck of the draw. It succeeds because it follows a design, a process that brings it from conception to operations and continually maintains the delicate balance of a win/win—the double win—for both sponsors’. Should the hypothesis that S.E.A. businesses choose only to work with business associates from their existing, related or extended networking, then there is reason to believe that such ‘relationships’ are important and looking after the partner(s)' interests is important in ensuring the success of the proposed alliance. Building trust, communication, perspective taking, rapport building and commitment are attributes to the process of looking after the partners' interest. (Spekman, Isabella, MacAvoy and Forbes III, 1996)

Observations under mutual interests issues,

1. S.E.A. businesses consider that looking after the partner(s) interests is just as important, in ensuring the success of the proposed alliance.

2. S.E.A. businesses normally do consider the strategic interdependence of its partner(s).

3. S.E.A. businesses normally look for a win/win formula for every partner in the business alliance.

Drucker (1992) argued that alliances tend to get into serious trouble when they are successful. This was because often, when an alliance does well, it became apparent that the goals and objectives of the partners were not compatible. Argandona (1999) shared similar observation in that alliances is at times considered to have been forged under conditions of both prosperity and adversity and changes over time can have a direct or indirect effect on the other party's objectives. If such cases were prevalent indeed, then it would suggest that strategic business alliances would normally gain satisfactory alliance benefit payoffs. Numerous researchers have preached that it was necessary to get the ‘goals and objectives’ right at the start (Yoshino and Rangan, 1995; Lorange and Roos, 1992; Lynch, 1993; Lewis, 1990; Michael, Andrew & Marcus, 1994).

Lorange and Roos (1992) explained that traditional short-term oriented financial measures are not valid measures. Also, because alliances normally have multiple parents and though one might consider the alliance a success, the others might see it as a failure instead. In consideration of Anderson's (1990) ‘input-output continuum’, it would be interesting to know what strategic benefits SEA businesses specifically look for.

Hatfield and Pearce's research study into the goal achievement and satisfaction of joint venture partner suggested that joint venture strategy might be better suited to achieving operational efficiency goals than financial goals. They quoted difficulties of insufficient time (or short life span of the joint venture), complex inherent structure, and the possibility of disagreement between the partners on achieving financial goals. Also suggested was the opportunistic possibility that with market access or knowledge transfer goals, one firm may contribute more than it gains or vice versa for that particular goal (Hatfield and Pearce, 1994).

Observations under intangible benefit issues,

1. More intangible net benefits (i.e. strategic and/or competitive advantages) are derived from successful S.E.A. alliances than tangible net benefits (i.e. financial performance and market share).

2. S.E.A. businesses do consider that through strategic alliances, they could increase their market coverage.

3. S.E.A. businesses do consider that through strategic alliances, they could increase their regional or international market coverage.

4. S.E.A. businesses do consider that through strategic alliances, they could increase the speed of business implementation.

5. S.E.A. businesses do consider that through strategic alliances, they could increase the speed of regional or international business implementation.

6. S.E.A. businesses usually team up with their competitors, as their strategic alliance partners

7. S.E.A. businesses usually team up with providers of technical know-how, market, product/service idea, business networks and resources as their strategic alliance partners.

Professor Mendoza, in his article on corporate ‘Paternalism’ (Mendoza, 1991, p.148) as a strategy to managing companies, argued that many of SEA successful companies practiced ‘paternalism’ and that by allowing their Asian spirit to shine through to their work, they have transformed modern management technology into an Asian tool that fits and works well in Asian hands. Pant and Rajadhyaksha, (1996) highlighted that family-controlled firms and the state-owned enterprises are the most common ownership structures in Asia. They cautioned that family control in firms creates special concerns that alliance partners should anticipate. Michael, Andrew and Marcus argued that corporate strategy that guide corporate-level decisions should relate to the four observations of how new business ventures could be structured, and how the ‘parent’ could influence and relate to the business under its control (Michael, Andrew & Marcus, 1994).

Observations under parenting management issues,

1. S.E.A. businesses usually employ a ‘paternalistic’ parenting strategy towards managing the alliance ‘child’.

2. S.E.A. businesses usually do not have a policy on how the ‘parent’ company should influence and relate to the alliance under its control.

3. When two or more partner(s) unite to pursue a set of agreed upon goals, the alliance itself should remain independent, subsequent to the formation of the alliance.

4. S.E.A. businesses usually do not allow its ‘child’ the business alliance to function independently.

Formation Stage, Expected Alliance Benefits Payoff Mapping

Three further observations are raised here to establish the degrees of confidence of the relationship between, the ‘Friendly’ alliance strategy and its corresponding levels (‘Poor, Satisfactory, and “Excellent’) of expected, or real ‘benefit payoffs’.

Observations,

1. When S.E.A. businesses adopt the ‘friendly’ alliance strategy, net strategic benefits are usually expected to be poor, when the chemistry between partners are poor.

2. When S.E.A. businesses adopt the ‘friendly’ alliance strategy, net strategic benefits are usually expected to be moderate, when the chemistry between partners are moderate.

3. When S.E.A. businesses adopt the ‘friendly’ alliance strategy, net strategic benefits are usually expected to be excellent, when the chemistry between partners are excellent.

Following Lynch's (1992) ‘Risk and Reward Analysis’ on alliance payoffs, in all three of the strategies adopted, the corresponding rewards for strategic alliances are ranked moderately. Except, for the joint venture which, when a cooperative strategy is adopted, is proposed to yield the greatest rewards. Drucker (1992) suggests that alliances will get into serious problems when they are performing well. This concern over the performance of alliances seems to suggest that most enduring alliances yield only moderate (i.e. Satisfactory) rewards or benefit payoffs, most of the time.

Observations under benefits of strategic alliance,

1. Successful S.E.A. strategic alliances normally yield poor tangible net benefits (i.e. financial benefits) to its partners.

2. Successful S.E.A. strategic alliances normally yield moderate tangible net benefits (i.e. financial benefits) to its partners.

3. Successful S.E.A. strategic alliances normally yield excellent tangible net benefits (i.e. financial benefits) to its partners.

4. Businesses normally expect to derive poor level of chemistry from the business alliance.

5. Businesses normally expect to derive moderate level of chemistry from the business alliance.

6. Businesses normally expect to derive excellent level of chemistry from the business alliance.

7. Businesses normally want its parent company to do better than the business alliance.

Failure Stage Mapping

At the 4th MIT-NTU Conference on ‘Strategic Alliance: Gateways to Creating Learning Organisations’, Associate Professor Toh Thian Ser (Vice-Dean of the School of Accountancy and Business, Nanyang Technological University of Singapore) warned that entering into alliances without giving thought to the nature of alliance could be risky because while it is easy to enter into an alliance, it is difficult to exit. Alliances are a bit like marriage; companies often get together thinking that they have got a lot in common and then, for the least likely reason, things start to go wrong. (Pangarkar, 1999) Also, partners do operate with hidden agendas. It is of marginally more useful to say that partners ought to take a more critical stance in the evaluation of the benefits of an alliance. But then, cultural audit that exposes the partner's hidden agenda and aspects of its corporate culture would likely make reconciliation unworkable at times. (Shaughnessy, 1995) Extending from this thought and following from the argument that business relationships is more important and that ‘exit’ could be difficult would suggest that S.E.A. businesses would reconcile their differences to improve poor alliance performance.

Observations under failure, performance management issues,

1. Businesses that normally do not perform well have partners that could not work together.

2. Businesses will normally reconcile their differences to improve alliance performance, when the alliance is performing poorly and partners' relationships are hostile.

3. Businesses will normally choose to exit by selling-out when the alliance is performing poorly and partners' relationships are hostile.

4. Businesses will normally choose to liquidate the business alliance when it is performing poorly and partners' relationships are hostile.

Following Drucker's arguments again that strategic business alliances would normally gain moderate benefits because when they are successful, it became apparent that the goals and objectives of the partners were not compatible. Spekman, Isabella, MacAvoy and Forbes III, (1996) also noted that partners prefer to manage what they own but alliances require that both firms takes into consideration the needs and requirements of the venture in plotting its own (and its partner's) business future. However, if the strategic benefits of ‘learning, market access, technology, etc’, could be important in the middle term (Anderson, 1990; Kanter, 1990), then SEA businesses might be willing to make the effort to resolve their mutual differences and mistrusts. Considering the Asian setting in this research, it is interesting to quote a famous Chinese proverb, which says that ‘there are no everlasting friendships, and there are no eternal animosity’.

Observations under conflict resolutions issues,

1. S.E.A. businesses will normally make the effort to resolve conflicts and pursue friendly reconciliation when partner relationships are hostile, but net strategic benefits are moderate.

2. S.E.A. businesses normally view that learning from the partner(s) about their technical know-how and/or market access is most important and any hostility should be resolved or restrained.

3. S.E.A. business alliances eventually face difficulties that threaten the survival of the alliance, when they are performing very well.

Yoshino and Rangan have made the observation that maintaining a balance between competition and cooperation is a major challenge in alliance management. Jan Stiles (1995) also noted that different industrial backgrounds with dynamic market requirements would cause partners to find themselves increasingly working towards different strategic goals, this leads to incompatibility of which eventually would result in the breakdown of the relationship. Lynch have warned that when partners' ‘Chemistry’ have turned bad; an alliance could be the prelude to a takeover attempt. This is the reason why Yoshino and Rangan (1995) have prescribed the necessity to ‘create fall-back positions’ and this is also why S.E.A. businesses might consider that a ‘Control’ strategy by way of a takeover would offer more strategic benefits in the future.

Observations under failure: control strategy issues,

1. S.E.A. businesses normally consider that a strategy of de facto ‘Control’ offers more strategic benefits in future than cooperative strategy does, when partner relationships are currently hostile and net strategic benefits are moderate.

Following the rationale given above, when partnership relationship are beyond reconciliation, but with the incentive of excellent benefits, one partner would be tempted to buy-out and/or to gain control of the other partner.

Observations under hostile relationship management issues,

1. When partner(s) relationships are hostile but the net strategic benefits are excellent, than one partner will attempt to buy-out or to control the other partner.

2. When partner(s) relationships are hostile but the net strategic benefits are excellent, then partners will choose to make an effort to settle their difference and pursue friendly reconciliation.

Failure Stage, Expected Alliance Benefits Payoff Mapping

Three observations are raised here to establish the degrees of confidence of the relationship between, the ‘Hostile’ alliance strategy and its corresponding levels (‘Poor, Satisfactory, and “Excellent’) of expected, or real ‘Benefit payoffs’.

Observations,

1. Businesses adopt the ‘Hostile’ alliance strategy when the business alliance is expected to yield poor strategic benefits and better chemistry is not expected to improve the performance of the alliance.

2. Businesses adopt the ‘Hostile’ alliance strategy when the business alliance is expected to yield excellent strategic benefits to the partner with effective control over the business.

3. Businesses adopt the ‘Hostile’ alliance strategy when the business alliance is expected to yield moderate strategic benefits and better control over the business is expected to improve the performance.

3-Dimensional Mapping Framework on Strategic Alliance Dynamism

Yoshino and Rangan's (1995) research have suggested that the alliance ‘structure’ provides the setting for the ongoing interaction between the alliance partners, and that partners' strategic and operational objectives, whether stated or hidden, could be achieved only if the alliance structure permits. Also, it could serve ‘to conserve a firm's options for the future’, where the business alliance structures need to be designed to provide maximum flexibility. This is also consistent with other researchers and practitioners (Lewis, 1990; Lorange and Roos, 1992; Lynch, 1992).

Observations under alliance structure issues,

1. S.E.A. businesses consider that a suitable alliance structure is important to the future development of stronger alliance relationship and performance.

2. S.E.A. businesses are not too obsessed with equity ownership structures.

3. S.E.A. alliance managers are usually able to get what they want from the ambiguous alliance relationship.

4. S.E.A. businesses usually consider the structure of the alliance to be the setting for the on-going interaction between alliance partner(s).

5. S.E.A. businesses usually consider that the partners' strategic and operational objectives, whether stated or hidden, could be achieved only if the alliance structure permits.

6. S.E.A. businesses usually prefer alliance structures that provides maximum flexibility that do not limit the partner(s)' space to maneuver.

7. S.E.A. businesses usually prefer equity based alliance structures to those that are based on contracts or are by non-contractual agreements.

8. S.E.A. businesses usually prefer hierarchical functional alliance structures over those that are more oriented towards arm-length market ones.

Lynch (1992), stated that alliances require both ‘Operational Fit’ and ‘Strategic Fit’, in addition to the ‘Chemistry Fit’. Lorange and Roos (1992) defined strategic alliances as degrees of ‘Vertical Integration’ and ‘Inter-dependence’. By these arguments, an alliance would have to integrate its operations into both its parent's business value chains. Arguably, S.E.A. businesses are considered to be more entrepreneurial in business strategy and contemporary business management, S.E.A. businesses may not practice value-chains integration processes.

Observations under strategy boundary/integration issues,

1. S.E.A. businesses do not normally (vertically or horizontally) integrate their parent businesses to the ‘value chains’ of the alliance.

2. S.E.A. businesses do normally leverage on both the parent's in-house and the partner(s)' resources and skills.

3. S.E.A. businesses normally leverage on the partner(s)' financial and physical resources.

4. S.E.A. businesses normally leverage on the partner(s)' market accessibility.

5. S.E.A. businesses normally leverage on the partner(s)' social, business and government networking capabilities.

6. S.E.A. businesses normally leverage on the partner(s)' technical know-how and specialized skills.

7. S.E.A. businesses normally leverage on the partner(s)' products/service innovations.

Mapping on ‘Alliance Structure’ in the 3-D Process Matrix

In this case, a 3-Dimensional matrix yields 27 (i.e. 3×3×3) situations. The 2-Dimensional mapping on alliance strategy and performance has been shown to be an incomplete approach to studying strategic alliances, unless the element of alliance structure is considered. Otherwise a proper analysis on the dynamism of strategic alliance processes will not be realistic. Upon relating the ‘alliance strategy-performance scenarios’ to the choice of ‘alliance structures’, 27 questions have been raised to establish the degree of relationships between the ‘Alliance Structure; Loose, Tight and Amalgamated’, to the ‘Alliance Strategy; Passive, Friendly and Hostile’, and ‘Alliance Performance; Poor, Satisfactory and Excellent’.

Observations,

‘Passive-Poor’ Scenario

1. When S.E.A. businesses adopt the sleeping investor, or ‘Passive’ strategy towards a business alliance and that only ‘Poor’ partners could be found, the most likely strategic business alliance that will be entered into is one that has a ‘Loose’ structure.

2. When S.E.A. businesses adopt the sleeping investor, or ‘Passive’ strategy towards a business alliance and that only ‘Poor’ partners could be found, the most likely strategic business alliance that will be entered into is one that has a ‘Tight’ structure.

3. When S.E.A. businesses adopt the sleeping investor, or ‘Passive’ strategy towards a business alliance and that only ‘Poor’ partners could be found, the most likely strategic business alliance that will be entered into is one that has an ‘Amalgamated’ structure.

‘Passive-Moderate’ Scenario

1. When S.E.A. businesses adopt the sleeping investor, or ‘Passive’ strategy towards a business alliance and that only ‘Satisfactory’ partners could be found, the most likely strategic business alliance that will be entered into is one that has a ‘Loose’ structure.

2. When S.E.A. businesses adopt the sleeping investor, or ‘Passive’ strategy towards a business alliance and that only ‘Satisfactory’ partners could be found, the most likely strategic business alliance that will be entered into is one that has a ‘Tight’ structure.

3. When S.E.A. businesses adopt the sleeping investor, or ‘Passive’ strategy towards a business alliance and that ‘Satisfactory’ partners could be found, the most likely strategic business alliance that will be entered into is one that has an ‘Amalgamated’ structure.

‘Passive-Excellent’ Scenario

1. When S.E.A. businesses adopt the sleeping investor, or ‘Passive’ strategy towards a business alliance and that ideal partners have be found, the most likely strategic business alliance that will be entered into is one that has a ‘Loose’ structure.

2. When S.E.A. businesses adopt the sleeping investor, or ‘Passive’ strategy towards a business alliance and that ideal partners have be found, the most likely strategic business alliance that will be entered into is one that has a ‘Tight’ structure.

3. When S.E.A. businesses adopt the sleeping investor, or ‘Passive’ strategy towards a business alliance and that ideal partners have be found, the most likely strategic business alliance that will be entered into is one that has an ‘Amalgamated’ structure.

‘Friendly-Poor’ Scenario

1. When S.E.A. businesses adopt the ‘Friendly’ alliance strategy, but the chemistry between partners are ‘Poor’, the most likely strategic business alliance that will be entered into is one that has a ‘Loose’ structure.

2. When S.E.A. businesses adopt the ‘Friendly’ alliance strategy, but the chemistry between partners are ‘Poor’, the most likely strategic business alliance that will be entered into is one that has a ‘Tight’ structure.

3. When S.E.A. businesses adopt the ‘Friendly’ alliance strategy, but the chemistry between partners are ‘Poor’, the most likely strategic business alliance that will be entered into is one that has a ‘Amalgamated’ structure.

‘Friendly-Moderate’ Scenario

1. When S.E.A. businesses adopt the ‘Friendly’ alliance strategy, but the chemistry between partners are ‘Satisfactory’, the most likely strategic business alliance that will be entered into is one that has a ‘Loose’ structure.

2. When S.E.A. businesses adopt the ‘Friendly’ alliance strategy, but the chemistry between partners are ‘Satisfactory’, the most likely strategic business alliance that will be entered into is one that has a ‘Tight’ structure.

3. When S.E.A. businesses adopt the ‘Friendly’ alliance strategy, but the chemistry between partners are ‘Satisfactory’, the most likely strategic business alliance that will be entered into is one that has a ‘Amalgamated’ structure.

‘Friendly-Excellent’ Scenario

1. When S.E.A. businesses adopt the ‘Friendly’ alliance strategy, but the chemistry between partners are ‘Excellent’, the most likely strategic business alliance that will be entered into is one that has a ‘Loose’ structure.

2. When S.E.A. businesses adopt the ‘Friendly’ alliance strategy, but the chemistry between partners are ‘Excellent’, the most likely strategic business alliance that will be entered into is one that has a ‘Tight’ structure.

3. When S.E.A. businesses adopt the ‘Friendly’ alliance strategy, but the chemistry between partners are ‘Excellent’, the most likely strategic business alliance that will be entered into is one that has a ‘Amalgamated’ structure.

‘Hostile-Poor’ Scenario

1. When S.E.A. businesses adopt the ‘Hostile’ alliance strategy and the business alliance is expected to yield ‘Poor’ strategic benefits, the most likely strategic business alliance that will be entered into is one that has a ‘Loose’ structure.

2. When S.E.A. businesses adopt the ‘Hostile’ alliance strategy and the business alliance is expected to yield ‘Poor’ strategic benefits, the most likely strategic business alliance that will be entered into is one that has a ‘Tight’ structure.

3. When S.E.A. businesses adopt the ‘Hostile’ alliance strategy and the business alliance is expected to yield ‘Poor’ strategic benefits, the most likely strategic business alliance that will be entered into is one that has an ‘Amalgamated’ structure.

‘Hostile-Moderate’ Scenario

1. Businesses adopt the ‘Hostile’ alliance strategy when the business alliance is expected to yield ‘Satisfactory’ strategic benefits, and the most likely strategic business alliance that will be entered into is one that has a ‘Loose’ structure.

2. Businesses adopt the ‘Hostile’ alliance strategy when the business alliance is expected to yield ‘Satisfactory’ strategic benefits, and the most likely strategic business alliance that will be entered into is one that has a ‘Tight’ structure.

3. Businesses adopt the ‘Hostile’ alliance strategy when the business alliance is expected to yield ‘Satisfactory’ strategic benefits, and the most likely strategic business alliance that will be entered into is one that has a ‘Amalgamated’ structure.

‘Hostile-Excellent’ Scenario

1. When S.E.A. businesses adopt the ‘Hostile’ alliance strategy and the business alliance is expected to yield ‘Excellent’ strategic benefits, the most likely strategic business alliance that will be entered into is one that has a ‘Loose’ structure.

2. When S.E.A. businesses adopt the ‘Hostile’ alliance strategy and the business alliance is expected to yield ‘Excellent’ strategic benefits, the most likely strategic business alliance that will be entered into is one that has a ‘Tight’ structure.

3. When S.E.A. businesses adopt the ‘Hostile’ alliance strategy and the business alliance is expected to yield ‘Excellent’ benefits, the most likely strategic business alliance that will be entered into is one that has an ‘Amalgamated’ structure.

The present invention may be embodied in other specific forms without departing from the spirit or essential characteristics thereof. The presently disclosed embodiments are, therefore, to be considered in all respects as illustrative and not restrictive, the scope of the invention being indicated by the appended claims and all changes which come within the meaning and range of equivalency of the claims are, therefore, to be embraced therein. For instance, the present invention may be implemented online via communication links such as the internet.

I claim:

1. A multi-dimensional method for simulating the alliance of enterprises, said method comprising the steps of
analyzing the alliance fitness of an alliance according to a two dimensional process mapping of alliance strategy and performance, said process mapping supposing that enterprises in an alliance strive to achieve a win/win situation, said alliance having at least two enterprises;
correlating the structure of said alliance with the strategy and performance mapping in deriving a multi-dimensional spatial representation of said alliance; and
predicting various subsequent combination of alliance outcomes with reference to the optimal win/win situation,
whereby managerial and alliance resources may targeted at the appropriate stages while ensuring the durability and stability of said alliance.

2. A multi-dimensional method for simulating the alliance of enterprises according to claim 1 wherein said two dimensional process mapping correlates alliance strategies with passive, friendly and hostile attitudes respectively.

3. A multi-dimensional method for simulating the alliance of enterprises according to claim 1 wherein said two dimensional process mapping correlates alliance performance with poor, satisfactory and excellent outcomes respectively.

4. A multi-dimensional method for simulating the alliance of enterprises according to claim 1 wherein the correlation of the structure of said alliance with the strategy and performance mapping is determined by reference to a plurality of processes.

5. A multi-dimensional method for simulating the alliance of enterprises according to claim 4 wherein said plurality of processes comprise at least one rationalization process, at least one formation process and at least one failure process.

6. A multi-dimensional method for simulating the alliance of enterprises according to claim 5 wherein said the strategy, structure and performance of an alliance are correlated the degree of separability of an alliance asset.

7. A multi-dimensional method for simulating the alliance of enterprises as in claim 1 wherein said analysis, correlation and prediction are conducted via at least one communication link.

8. A multi-dimensional method for simulating the alliance of enterprises as in claim 1 wherein said communication link is a computer like between enterprises and professional advisers.
